(19) United States
(12) Patent Application Publication
(10) Pub. No.: US 2018/0033062 A1
(43) Pub. Date: Feb. 1, 2018

(54) PURCHASE INCLUDING PUSH TRANSMISSION FROM PURCHASER TO FUTURE PURCHASER

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 15/730,676

(22) Filed: Oct. 11, 2017

Related U.S. Application Data
(63) Continuation-in-part of application No. 14/464,648, filed on Aug. 20, 2014, now abandoned.
Application No. 14/464,648 is a continuation-in-part of application No. 14/599,839, filed on Jan. 19, 2015.
(60) Provisional application No. 61/881,287, filed on Sep. 23, 2013.
(60) Provisional application No. 61/881,246, filed on Sep. 23, 2013.
(60) Provisional application No. 61/881,287, filed on Sep. 23, 2013.

(51) Int. Cl. G06Q 30/06; G06Q 30/02; G06Q 50/00

(52) U.S. Cl. CPC G06Q 30/0613; G06Q 50/01; G06Q 30/0277; G06Q 30/0257; G06Q 10/083

(57) ABSTRACT

A system and method are provided for encouraging online shoppers to share online purchase transactions. Included are online advertisements or offers at the point of checkout. These offers indicate an incentive for sharing information about the online purchase on one or more social network platforms of the online shopper. The system may also include a pre-made or subsequently created video component featuring the product or a statement or opinion about the product. When the online shopper indicates a willingness to share in order to receive the incentive the video component featuring the product or a link thereto is displayed on the online shopper's social network platform as a posting in a newsfeed, on a profile page, or as a status update for the social network connections of the online shopper to see. The social network connections can then purchase, share, redeem and offer incentives as well.

### RELATED APPLICATION(S)

This application claims the benefit of U.S. patent application Ser. No. 61/881,246 entitled “SYSTEM AND METHOD FOR PURCHASING BY SOCIAL NETWORK STATUS UPDATE OR POST,” filed on Sep. 23, 2013; and U.S. patent application Ser. No. 61/881,287 entitled “SYSTEM AND METHOD FOR VIRAL PURCHASING,” filed on Sep. 23, 2013; the substance of which are incorporated herein in their entirety, by way of U.S. patent application Ser. No. 14/464,648 filed Aug. 20, 2014 in the name of the same inventors, and U.S. patent application Ser. No. 14/464,628 filed Aug. 28, 2014 in the name of the same inventors, and U.S. patent application Ser. No. 14/599,839 filed Feb. 2, 2015 in the name of the same inventors, for which the priority and benefit are also claimed and the entirety of which are also incorporated herein by this reference.

### FIELD OF THE INVENTION

The present invention relates to enabling purchase transactions having therein push transmission in an electronic network by allowing a first purchaser to create a social transmission to a potential future purchaser.

### BACKGROUND

Numerous devices have been used to enhance purchase transactions. From the original invention of currency easing commerce by making it easier to carry wealth and easier to trust that a payment made was real, through the invention of negotiable instruments, advertisements, cash registers, credit cards, calculators, debit cards and so on down to POS terminals (Point of Sale) stations, the online shopping cart, and more, the devices used to allow transactions have become simpler and more effective as time has progressed.

The internet is often used for purchases of all sorts of products and services without geographic limitation to traditional brick and mortar stores. This leads to increased variety of offerings to the individual internet-savvy consumer along with better prices due to increased competition, fewer middlemen, reduced overhead, and resale not to mention savings of gas and time compared to traditional in-person shopping. Websites likely eBay, Amazon, and Craigslist proliferated and payment processors like PayPal took care of the backend in an area of internet commerce.

Behind them stands the entire banking system of purchaser's banks, intermediary banks, secure links connecting them, the seller's bank and so on. These have in fact become a communication network all their own.

More recently, social networking websites have emerged as a powerful interpersonal communication medium. As used herein the term and adjective “social networking” as used with website/forum/platform is used broadly to include all variations of networking to include, for example, professional networking, personal networking, special interest forums, blogs, short messaging and so on. In increasing numbers individuals are signing up to join various social networking platforms and sharing information about themselves, making new friends or keeping in touch with existing friends/classmates/family/colleagues/coworkers and other real-life connections, and forging new relationships, even with unknown individuals across the globe or friends-of-friends and higher order connections that may or more not leave the virtual realm to meet face-to-face.

The benefits of social network are numerous in that it provides an easy way to stay in touch with many people simultaneously, serves as a news resource, lets certain things be known to everyone (or selected groups) in a user's network without taking the time to tell each person, provides a platform to ask questions with real people answering, allows a user to answer others' questions as a starting point for a future relationship, and provides an outlet to advertise a user or a business for free or low cost.

The value of social media in rapid dissemination of information is enormous. For example, in 2012 the humanitarian group Invisible Children released a short film documenting the activities of the international fugitive Joseph Kony. Word of the video went viral on social networks and in less than a week after launch, the video had been viewed over 100 million times. Another example of the power of social media is the fact that the term “went viral” does not require quotation marks. Also in 2012, the Nike shoe corporation launched the #makeitcount social media campaign and saw an increase in profits of 18%. Efforts like this inspired other for-profit or for-gain advertising on social media: nearly all political campaigns now have social media operations.

However, it has been noticeable that social media itself is somewhat slow to serve as an actual transaction enhancing medium. That is, social media may support person to person messaging, or online shopping carts, or credit card usage or the like, but it is not found that the social media itself becomes a purchase enhancing link between a first buyer and future purchasers.

Turning away from the question of purchase enhancement to the question of advertising, it is clear that advertising is a dominant factor in modern commerce. In fact, purchase enhanceement should be core to advertising. It is thus useful to change the subject and analyze modern internet advertising and promotion.

More recently, internet commerce has begun to merge with social networking in the form of individuals making purchase decisions and being directed to purchase products of interest based on referrals from friends or connections in a social networking forum. After all, before the internet and still today many people make purchasing decisions based on things seen and liked bought by friends, relatives, and co-workers and based on talking to these individual people about their experiences with a particular product. With more people spending more time looking at a computer, tablet computer, smart phone, or other internet connected device through which they can check-in with their social networking forums of interest, it comes as no surprise that purchase decisions of today and of the future will be strongly influenced by events in social networking forums. Specifically, if a user is online on any of of their preferred social networking websites and they see a friend, someone whom they follow, a follower, a connection, a fellow group member, or other direct or indirect contact (there are numerous terms and types of communication relationships) and that individual is posting about something which the user then notices and likes, or which they recommend, or just the mere fact that they purchased something, this tends to increase interest in the product, or merely create brand or product awareness in the user.

There are also various types of social media advertising campaigns. The prototypical type of campaign is the electronic word of mouth campaign or eWOM, in which users are encouraged to proactively post (communicate) about a company. A slightly more artificial campaign type is the COBRA, consumer online brand related activity campaign, in which consumers are urged to post regarding their brand loyalty. These campaigns might be of low cost in some circumstances, with the motivator or incentive merely being a prize or even just social proof, that is, the tendency of individuals to assume that the behavior of others around them must be the correct behavior, after which imitation is likely.

Nonetheless, there are some drawbacks to purchasing products online. For example, many online sellers charge the purchaser for shipping and sometimes charge for online order or payment processing. Another non-monetary drawback is the inability to accurately access product quality due to seeing only a picture and being unable to physically inspect the product in person as one would do in a traditional brick and mortar store environment. If there is still a savings by purchasing a product online together with the shipping and online transaction costs than many people will still purchase online as long as they are familiar with a product they are purchasing, trust someone else's judgment on a product with which they are not familiar (e.g. online reviews), the company has a friendly return policy, or they are not risk averse.

A drawback to online transactions for sellers is that they do not always benefit from the physical advertising real world shoppers can do by visiting a store in person and then walking around town with shopping bags advertising where they have spent their money. In this manner, ordinary shoppers provide a subtle yet visible endorsement to brick and mortar stores. Similarly, the buyer will usually have to wait a considerable time for their purchased product to arrive, during which they are excited to have made the purchase but lack the physical item as a display to others they associate with.

It would be advantageous to provide not just a purchase enhancement mechanism but also a social media advertisement which doubles as a purchase enabling device.

US Patent Publication No. 2014/0012655 to POLAK and filed on Jan. 9, 2014, states in the first line of the abstract that it teaches “a method of receiving discounts in exchange for social media advertising of items in a store”, including using an app on a mobile device which the user carries into the brick and mortar store, physically scanning the QR code of the physical product while the user is standing in the store and allowing the app to retrieve a discount offer (or other information) which the user in the brick and mortar store may use in exchange for advertising the item on a social media system. FIG. 11, PRIOR ART, shows this type of system. FIG. 11 is a PRIOR ART diagram of a user standing in a brick-and-mortar store, scanning QR codes on products and then getting a discount at a POS station.

The user 130 is seen standing inside of store 115, with QR code 123 visible on items in the store. And paragraph 0009 of the reference explicitly repeats “ . . . a system and method for a customer to receive discounts for an item at a store by publicizing the item in a social network . . . performed by entering an item code that appears on or near the item . . . ” Thus that item of art is directed toward scanning a physical QR code on a physical product and then posting an advertisement to social media. It teaches away from online sales transactions, and these are possible only AFTER the user has downloaded the app, searched, scanned QR codes and so on. Thus it would be preferable to provide a system which applied to online shopping and purchasing without Polak's initial in-store steps.

Note that the present invention does not claim generic “online shopping”, but rather online shopping and in the midst of the online checkout, an automatic offer regarding social advertising by the purchaser. Polak mentions online shopping only in a generic sense and after in-store scanning of QR codes, which this application does not claim.

In order, a user of the Polak system would first download a special app to their mobile device having a camera. 2) They would then take the mobile device to a store and scan the QR codes 123 of items 122 found in the store 115, or search for products. 3) By using the app 300 they can post advertisements for the products they find in the store. After that point, the user could then go through a check out process at which point they would receive a discount. Note that at this checkout process, they would receive a notification and a discount initiated only by their efforts in downloading, searching, going to the store, scanning, and then advertising. (The user could at least finally purchase the product online if the retailer allows it and the retailer is part of the system.) It would be preferable for all shoppers to receive a notification, and in an online setting free of the download/scan QR hassles imposed by Polak.

It is worth noting this system's shortcomings. It would be preferable to provide a system not requiring the user to download a special app 300 and scan and so on. It would instead be preferable to provide a system in which anyone can be automatically notified of the existence of a discount in exchange for social advertising, and for this to happen at the moment of an actual purchase, not over the course of a long preprocess the user must carry out.

Furthermore, the Polak patent teaches an awkward multi-part and even multi-location system of the following steps: 1) download app 2) go to store and 3) scan QR codes in store 4) publicize products by social post 5) begin checkout process & then 6) receive discount; but it would be preferable to provide a fast system which follows the fewer steps of: 1) during any online purchase, receive an automatic offer of a discount 2) post to social media quickly and 3) finish the same purchase transaction.

Thus the Polak patent does not offer an automatic notification to the first purchaser: 1) a download app, 2) scan in store process/search process is required. It would be preferable to provide an automatic notification at the point of checkout without requiring the user to download the app 300 or scan QR codes on items 122.

In addition, the Polak patent shows pictures or videos inside of the application 300, rather than on social media. It would be preferable to provide a picture or video first during the checkout process, in fact, to checkout from a video player, and then secondly provide videos on social media, rather than merely pictures displayed inside of the Polak application 300, as Polak indicates in Para. 0077.

Furthermore, the efficacy and usefulness of a social media advertisement will be greatly improved if it could be professionally prepared in advance. Thus it would be preferable to provide an advertisement which is premade and which the user can easily insert. This advertisement can be clearly distinguished from a “like” or similar button push by being video. If would be even further preferable to provide a library of different possible advertisements which the purchaser could select from among, rather than a sterile “like” or “thumbs up” or similar bland indication.

Furthermore, it would be preferable to provide the purchaser with tools which allow easy insertion of the advertisement into the social media. Such a tool would take the purchaser's choice of premade ad, or their customized advertisement (for example a selfie of their purchasing the product), and insert it more easily than the social network normally allows. Thus a social network which provides a boringly clone-like “like” button could be used circumvented and the purchaser could easily post a professional or personal video instead.

FIG. 12 is a PRIOR ART flow chart of a method of users sharing an online shopping cart, US Pat. Publ. 2009/0132311 to Klinger. In this MLM (multi-level marketing) scheme, a first user becomes a sort of commission-paid employee of an online business. The first user creates a shopping cart which they share on social media or through other channels, per the Abstract. If others buy from that shopping cart, the purchase is “tagged” and the first user is credited with the purchase, Klinger paragraph [0022].

According to paragraph [0034] of Klinger the preliminary step 201 (these are numbers from the prior art, not the present application) is for a business to enroll in the system and specify which items will be placed into the shopping cart. For example, the business may require users to bid, by price, in order to win the privilege of operating the shopping cart. In step 202 (para. [0035]) the user then creates social media content for advertising the shopping cart and posts (step 203) the members. Other social network members may then view the cart (step 204), and make purchases from the cart (steps 205/206), which causes a notification to the seller (step 207) and the provision of an endorsement fee or other monetary reward to the first user (step 208).

While this Klinger reference is not as different from the present invention as the Polak reference, it is nonetheless directed to a different activity. In particular while this is at least a set of online transactions, it is once again a process which is NOT initiated during a sale. It still requires the user to carry out various preparatory steps before they begin any purchase activity: bid for the right to operate a shopping cart, set up the shopping cart, post to social media about the shopping cart, and then finally at the end receive their commission.

Instead, it would be preferable, as stated previously, if an ordinary online purchaser could be informed after purchase that they can post about their purchase, post quickly and easily, the entire process being completed during the course of/after a single online purchase with the intention to drive sales back. It would be preferable for sellers to be able to make a normal media buy, and avoid multi-level marketing.

In certain understandings of purchaser mentality, it can also be more authentic and trustworthy to know that a friend, associate, family-member or the like is advertising a product WITHOUT an incentive, and have themselves just purchased the product with their own money.

It would be desirable for online consumers to purchase products online and to promote their online purchases to those they may be more likely to influence. It would also be desirable to provide ways for online shoppers to get to know the product they are purchasing better without actually being in the same physical place as the product or to have more reason to trust the product. This is done through the interactive nature of the video which informs the next purchasers about the product and its features and functions in an interactive way. Finally, it would be desirable to provide ways for online sellers to use online purchasers as online advertisers for products that they have purchased in the specific channels where they are likely to have the greatest impact. The present invention meets these and other needs.

It would further be preferable to provide a new paradigm for social network marketing, so as to provide advertisers a new channel of communication with social network users through the use of video.

### SUMMARY OF THE INVENTION

The above-discussed disadvantages of the reference art are overcome by the system and method of the present invention that provides a simple, yet elegant solution to 1) ENABLE transactions using a social network for the transaction, and simultaneously 2) motivate un-incentivized future online purchases and feature online products in videos. The present invention may be used with any social media platform/tool now known or later devised which meets the fundamental criteria of allowing users to post communications which are viewed by other users. Thus most blogs, Instagram, Twitter, Facebook, LinkdIn, Google+, Pinterest, similar services in other languages and so on all could be considered to fall within the scope of the framework within which the present invention operates. In addition, other tools which are not technically social media are in fact integral to the social media ecosystem, such as Youtube, Dailymotion, Digg, Reddit, Delicious, Periscope and so on.

As used herein, “POC” refers to point-of-checkout process, the process at which shopping ends and actual payment begins. “POC advertisement” refers to an advertisement a user receives while in any stage of the POC process.

According to a first aspect the invention provides a system for encouraging an online shopper to share information about an online purchase transaction, including an online advertisement at the point of checkout that indicates an opportunity for sharing information about a purchase of a product on one or more social network platform; and a video component featuring the product or a statement or opinion about the product in a video. The video component featuring the product or a link thereto is configured to be displayed on the online shopper's social network platform as a posting in a newsfeed, on a profile webpage, or as a status update for one or more social network connection of the online shopper to see when the online shopper indicates a willingness to share in order to receive the incentive. The system may also include a second online advertisement that indicates an opportunity for sharing information about the purchase of the product on one or more social network platform, wherein the second online advertisement is configured to be displayed along with the video component featuring the product on the online shopper's social network platform as a posting in a newsfeed, on a profile webpage, or as a status update for one or more social network connection of the online shopper to see when the online shopper indicates a willingness to share.

The video may be pre-made and ready to be shared immediately upon the online shopper's indication to share. Additionally, the video component displayed on the online shopper's social network may be selected by the online shopper from among multiple videos featuring the product or a statement or opinion about the product. In this manner, the online shopper can share a video that he/she is more likely to feel comfortable with their social network connections seeing, considering the type of social network or the type of connections. For example, the online shopper may want to share a funny video on a personal Facebook account but opt for a more sophisticated video to share on Linkedin. What is appropriate for social network connections on one social network to see may not be a wise choice for different social network connections on another social network.

The video may be created after the online shopper indicates a willingness to share. For example, the video may be created by the online shopper, e.g. with their smartphone video recorder camera. Or, the video may be created by an online merchant. Or, the video may be created by a third party that hosts the system.

According to a second aspect the invention provides a method for encouraging an online shopper to share information about an online purchase transaction that includes offering an opportunity to the online shopper after an online product item has been added to an online shopping cart of the online shopper but after or prior to checkout. The method further includes displaying a video featuring the product on a social network platform of the online shopper when the online shopper accepts the opportunity.

The method may further include displaying a second offer of an incentive to OTHER potential purchasers for purchasing the product on the social network platform of the online shopper when the online shopper accepts the opportunity. The second offer is displayed as a posting in a newsfeed, on a profile webpage, or as a status update for one or more social network connection of the online shopper to see. The second offer may be displayed along with the video featuring the product.

The method may also include clicking on the video featuring the product by a social network connection of the online shopper, and then purchasing the product by the social network connection of the online shopper. The method may further include clicking on the second offer by a social network connection of the online shopper, and then purchasing the product by the social network connection of the online shopper.

The method may further include sharing information about the purchase by the social network connection of the online shopper on a social network platform of the social network connection. In this manner publicity about the product and purchases thereof multiplies exponentially.

The information shared may be a video featuring the product.

It is thus a first aspect, embodiment, objective and advantage of the present invention to provide an online purchase system in which a first purchaser may, in during an online purchase of a product from a first seller, the online purchase being made on a purchase enabled device which is a software device, push a message onto a social media platform where it may be viewed by a second purchaser, the online purchase system comprising:

a first in-purchase advertisement from such first seller, the first in-purchase advertisement including an offer to such first purchaser to make a push transmission to such second purchaser via such social media platform;

a first in-purchase advertisement insertion module operative to insert the first in-purchase advertisement into such purchase automatically;

the first in-purchase advertisement insertion module operating automatically and without prior preparation on the part of such first purchaser;

a social advertisement selection module operative to offer to such first purchaser a plurality of social advertisements of such product from amongst which such first purchaser may select a second social advertisement;

the second social advertisement having a format suitable for posting onto such social media platform;

a second social advertisement insertion module operative to insert the second social advertisement onto such social media platform, whereby such second purchaser may receive it;

the first in-purchase advertisement insertion module and the second social advertisement insertion module entirely operative during and after such purchase;

such purchase enabled device operative to complete such transaction, including accepting payment.

It is thus another aspect, embodiment, objective and advantage of the present invention to provide an online purchase system wherein such purchase enabled device further comprises:

an online shopping cart.

It is thus another aspect, embodiment, objective and advantage of the present invention to provide an online purchase system wherein the insertion of the second social advertisement onto such social media platform further comprises one member selected from the group consisting of: posting the second social advertisement in a newsfeed, posting the second social advertisement in a profile webpage, posting the second social advertisement as a status update, and other forms of social network posting now known or later devised, and combinations thereof, but excluding from this group posting an indicia of liking such product.

It is thus another aspect, embodiment, objective and advantage of the present invention to provide an online purchase system wherein the first in-purchase advertisement, second social advertisement, first in-purchase advertisement insertion module, second social advertisement insertion module, and such purchase enabled device are stored as programming in a non-volatile memory of a central processing unit.

It is thus another aspect, embodiment, objective and advantage of the present invention to provide an online purchase system wherein such purchase enabled device is further operative to activate a shipping module, the shipping module operative to initiate a shipping process of such product to such first purchaser.

It is thus another aspect, embodiment, objective and advantage of the present invention to provide an online purchase system, wherein such purchase enabled device further comprises:

a purchase enabled video player operative to carry out such purchase, including at least the steps of: receiving from such first purchaser a notification of intention to buy such product, a step of automatically and without prior preparation on the part of such first purchaser inserting the first in-purchase advertisement into such purchase automatically, inserting the second social advertisement onto such social media platform.

It is thus another aspect, embodiment, objective and advantage of the present invention to provide an online purchase system, wherein the first in-purchase advertisement further comprises:

a first video, formatted to be played by the purchase enabled video player.

It is thus another aspect, embodiment, objective and advantage of the present invention to provide an online purchase system, wherein the second social advertisement further comprises:

a second video, formatted to be played after posting onto such social media platform.

It is thus another aspect, embodiment, objective and advantage of the present invention to provide an online purchase system, wherein the incentive to the second purchaser is a function of a number of social platform connections of such first purchaser.

It is thus another aspect, embodiment, objective and advantage of the present invention to provide an online purchase system, wherein the incentive to the second purchaser is a function of a number of social platforms to which such first purchaser posts the second social advertisement.

It is thus another aspect, embodiment, objective and advantage of the present invention to provide an online purchase system, wherein the plurality of social advertisements of such product from amongst which such first purchaser may select a second social advertisement are pre-recorded and formatted for immediate posting to such social platform by such first purchaser.

It is thus another aspect, embodiment, objective and advantage of the present invention to provide an online purchase system, wherein the second social advertisement is created by such first purchaser.

It is thus another aspect, embodiment, objective and advantage of the present invention to provide an online purchase system, wherein the second social advertisement further comprises: an embedded link operative to register a click from such second purchaser and in response activate such purchase enabled device, whereby such second user is enabled to purchase such product without activation of any software device other than such purchase enabled device.

It is thus another aspect, embodiment, objective and advantage of the present invention to provide an online purchase method in which a first purchaser may, in during an online purchase from a seller, the purchase made on a purchase enabled device, push a message onto a social media platform where it may be viewed by a second purchaser, the online purchase method comprising the steps of:

allowing such first purchaser to initiate such online purchase within such purchase enabled device;

2) during such online purchase, automatically display to such user a first in-purchase advertisement having an opportunity for making a second social advertisement to such second purchaser, the second social advertisement to be made via such social media platform, the first in-purchase advertisement inserted automatically into such online purchase without prior preparation by such first purchaser;

3) offering to such first purchaser a plurality of social advertisements of such product, from amongst which such first purchaser may select the second social advertisement; the second social advertisement having a format suitable for posting onto such social media platform;

4) posting the second social advertisement to such social media platform.

It is thus another aspect, embodiment, objective and advantage of the present invention to provide an online purchase method, wherein such purchase enabled device further comprises:

a purchase enabled video player.

It is thus another aspect, embodiment, objective and advantage of the present invention to provide an online purchase method, wherein the step 4) posting the second social advertisement to such social media platform further comprises one member selected from the group consisting of: posting the second social advertisement in a newsfeed, posting the second social advertisement in a profile webpage, posting the second social advertisement as a status update, and other forms of social network posting now known or later devised, and combinations thereof, but excluding from this group posting an indicia of liking such product.

It is thus another aspect, embodiment, objective and advantage of the present invention to provide an online purchase method, wherein the first in-purchase advertisement, second social advertisement, and such purchase enabled device are stored as programming in a non-volatile memory of a central processing unit.

It is thus another aspect, embodiment, objective and advantage of the present invention to provide an online purchase method, wherein such purchase enabled device is further operative to activate a shipping module, the shipping module operative to initiate a shipping process of such product to such first purchaser.

It is thus yet another aspect, advantage, embodiment and objective of the present invention to provide a sales system for encouraging an online shopper to share information about an online purchase transaction, the sales system for use with a first social network, the first social network having a plurality of users including first and second users, the first social network offering such users the ability to post to the first social network, the sales system further for use with an online purchase system, the online purchase system having a point-of-checkout process, the sales system comprising: a POC advertisement inserted into such point-of-checkout process, the POC advertisement offering to such first user an incentive for posting information about the purchase of a first product by such first user; a social advertisement selection module offering to such first user at least one social advertisement component for the sharing of information, the social advertisement component having a statement/opinion about the product; a social advertisement component insertion module which posts the social advertisement component to the first social network as a post of such first user.

It is therefore another aspect, advantage, embodiment and objective of the present invention to provide a method of online sales, wherein the social advertisement component further comprises a video component and the social advertisement selection module further comprises a video selection module and the social advertisement component insertion module further comprises a video component insertion module.

It is therefore another aspect, advantage, embodiment and objective of the present invention to provide a method of online sales, wherein the social advertisement component insertion module further posts a companion advertisement component to such first social network as a post of such first user, the companion advertisement displayed along with the video component.

It is therefore another aspect, advantage, embodiment and objective of the present invention to provide a method of online sales, wherein the video component is one member selected from the group consisting of: a video file, and embedded video player, a link to a video file, a link to a video player, a link to a video publically posted to a video sharing service and combinations thereof.

It is therefore another aspect, advantage, embodiment and objective of the present invention to provide a method of online sales, wherein the posting to such first social network further comprises one member selected from the group consisting of: posting in a newsfeed, posting to a profile webpage, posting as a status update, other forms of social network posting now known or later devised and combinations thereof.

It is therefore another aspect, advantage, embodiment and objective of the present invention to provide a method of online sales, wherein the statement/opinion is endorsed by such first user.

It is therefore another aspect, advantage, embodiment and objective of the present invention to provide a method of online sales, wherein the statement/opinion is such first user's own statement/opinion.

It is therefore another aspect, advantage, embodiment and objective of the present invention to provide a method of online sales, further comprising: a shipping module operative to ship the first product to such first user, such point-of-checkout process operative to activate the shipping module.

It is therefore another aspect, advantage, embodiment and objective of the present invention to provide a method of online sales, wherein modules and components of the sales system are stored as programming in a non-volatile memory of a central processing unit.

It is therefore another aspect, advantage, embodiment and objective of the present invention to provide a method of online sales, for use with a second social network having a plurality of users and offering the users the ability to post to the social network, wherein: the POC advertisement provides an additional incentive for posting on more than one social network.

It is therefore another aspect, advantage, embodiment and objective of the present invention to provide a method of online sales, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

It is therefore another aspect, advantage, embodiment and objective of the present invention to provide a method of online sales, wherein the video component is pre-made and ready to be posted immediately by such first user.

It is therefore yet another aspect, advantage, embodiment and objective of the present invention to provide a method of online sales wherein the social advertisement selection module offers to such first user a plurality of social advertisement components and allows such first user to select which social advertisement component is posted.

Therefore it is yet another aspect, advantage, embodiment and objective of the present invention to provide a method of online sales wherein the video component features the first user and is created by the first user using the video selection module.

It is therefore yet another aspect, advantage, embodiment and objective of the present invention to provide a method of online sales wherein the video component is pre-made by a party selected from the group consisting of: an online merchant, a third-party hosting the sales system and combinations thereof.

It is therefore yet another aspect, advantage, embodiment and objective of the present invention to provide a method of online sales wherein such point-of-checkout process further comprises allowing such first user to designate the first product to be purchased, and requiring such first user to pay for the first product; and further wherein the sales system comprises: inserting the POC advertisement into such point-of-checkout process at a step selected from the group consisting of: prior to designation of the first product, after designation of the first product; prior to paying for the first product; while paying for the first product, after paying for the first product, and combinations thereof.

It is therefore yet another aspect, advantage, embodiment and objective of the present invention to provide a method of online sales wherein the social advertisement component further comprises: an offer to such second user of an incentive for purchasing the first product and posting information about the purchase of a first product by such second user.

It is therefore yet another aspect, advantage, embodiment and objective of the present invention to provide a method of online sales wherein the social advertisement component further comprises: an embedded component operative to register a click from such second user and in response to the click activate such point-of-checkout process for such second user to purchase the first product.

It is therefore yet another aspect, advantage, embodiment and objective of the present invention to provide a method of online sales further comprising completing purchase of the first product by the social network connection of the second user.

It is therefore another aspect, advantage, embodiment and objective of the present invention to provide a method of online sales, for a first user having a first social network connection to a second user, the first social network connection allowing posting to the first social network, the method comprising the steps of: inserting into a point-of-checkout process of a first product a first advertisement offering to such first user an incentive for posting to such first social network a second advertisement; if such first user accepts such incentive, then posting to such first social network the second advertisement.

It is therefore another aspect, advantage, embodiment and objective of the present invention to provide a method of online sales, wherein the second advertisement further comprises on member selected from the group consisting of: a video file, and embedded video player, a link to a video file, a link to a video player, a link to a video publically posted to a video sharing service and combinations thereof.

It is therefore yet another aspect, advantage, embodiment and objective of the present invention to provide a method of online sales, wherein such posting further comprises one member selected from the group consisting of: posting in a newsfeed, posting to a profile webpage, posting as a status update, other forms of social network posting now known or later devised and combinations thereof.

And it is therefore yet another aspect, advantage, embodiment and objective of the present invention to provide a method of online sales, further comprising the steps of: offering to such first user a plurality of social advertisement components; allowing such first user to select which social advertisement component is posted; posting a a companion advertisement component to such first social network as a post of such first user, the companion advertisement displayed along with the video component; shipping the first product to such first user, such point-of-checkout process operative to activate the shipping module; inserting the point-of-checkout advertisement into such point-of-checkout process at a step selected from the group consisting of: prior to designation of the first product, after designation of the first product; prior to paying for the first product; while paying for the first product, after paying for the first product, and combinations thereof.

It is therefore yet another aspect, advantage, embodiment and objective of the present invention to provide a method of online sales, wherein the incentive to the first user is a function of one member selected from the group consisting of: a number of social network connections of such first user, a number of social network connections of such second user, a number of social networks to which such first user posts, a demographic indicia of such first user, a demographic indicia of such second user, and combinations thereof.

It is therefore yet another aspect, advantage, embodiment and objective of the present invention to provide a method of online sales, wherein steps of the method are stored as programming in a non-volatile memory of a central processing unit.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control. These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is an informal flow chart illustrating possible steps in a method according to an embodiment of the invention.

FIG. 2 is a schematic diagram of the components of a system according to an embodiment of the invention.

FIG. 2a is a block diagram of components and steps of the invention.

FIG. 3 is an exemplary chart of the spread of an advertisement according to the invention, through a partial social network, shown as a hierarchy for simplicity and clarity though social networks are in fact not usually hierarchical in organization.

FIG. 4 is an exemplary block diagram of a partial social network in which users receive a score based upon their number of communication links with other users of the network.

FIG. 5 is a block diagram showing physical components of a social network: though the physical components are the least important part of such a network they are shown for reference purposes.

FIG. 6 is an exemplary tabular data structure showing potential video advertisements which a user might select from based upon various important dimensions of suitability.

FIG. 7 is an exemplary tabular data structure showing potential non-video advertisements which a user might select from based upon various important dimensions of suitability.

FIG. 8 is a flow chart of the steps of the invention for the provision of a service, and payment, by a provider to a customer.

FIG. 9 is a flow chart of the steps of the invention for the provision of a product, and payment, by a seller to a buyer.

FIG. 10 is a PRIOR ART flowchart of steps of a user downloading and going to a store to scan QR codes.

FIG. 11 is a PRIOR ART diagram of a user standing in a brick-and-mortar store, scanning QR codes on products and then getting a discount at a POS station.

FIG. 12 is a PRIOR ART flow chart of a method of users sharing an online shopping cart.

### INDEX OF REFERENCE NUMERALS

Sales system 100
Products 102
Shopping cart 104
Incentive offer/POC Ad 106
Exemplary incentive offer 108
Decline 110
Accept offer 112
Checkout page 114
Social advertisement 116
Provide incentive 118
Post to social network 120
Viewing of incentive 122
Referred sale 124
Online shopping cart 202
Purchase enabled video player 204
Product in shopping cart 206
Purchase 208
First in-purchase advertisement 210
Insertion into purchase automatic 211
Social advertisement choices 212
Second social advertisement 214
Insertion into social media 215
Purchase completion 216
Incentive 218
Shipping 220
Product 222
First user/initial purchaser 302
Second user/wall/area 304
Companion advertisement 306
Video component 308
Third user 310
First user having 4 links 402
Second user having 0 links 404
Third user having 8 links 406
Third user rating: 8 408
Fourth user 410
Fourth user rating: 32 412
Social network/Internet 502
Merchant computer 504
Server computer w/NV mem 506
Consumer access device 508
Product (computer for sale) 510
Video component 512
Video selection module 514
Shipping module 516
User database 518
Other modules/components 520
Shop online 802
Checkout online 804
Receive first in-purchase ad 806
Use tools for quick post 808
Finish checkout with discount 810
Pay Link 812
Shop online 902
Checkout online 904
Receive first in-purchase ad 906
Use tools for quick post 908
Finish checkout with discount 910
Pay Link 912
Checkout screen/process 1000
Download app 1002
Go to store 1004
Scan QR code 1006
QR code 1008
Go home 1010
Post 1012
Shop online 1014
Checkout 1016
Payment process 1017
Receive discount 1018
Post 1020
Checkout 1022
Payment process 1023
Receive discount 1024
Incentive offer/first (POC) Ad 1100
Link 2100
Video 2200

### DETAILED DESCRIPTION OF EMBODIMENTS

Briefly and in general terms the present invention provides a system for encouraging an online shopper to share information about an online purchase transaction that includes an online advertisement and a video component featuring the product or a statement or opinion about the product in a video. The online advertisement may be an incentive offer that initially appears to a first social network user at the point of checkout. The online advertisement indicates an incentive for sharing information about the purchase of the product (that has already been selected) on one or more social network platform. The video component featuring the product or a link thereto is in fact a second, social media advertisement, configured to be displayed on the online shopper's social network platform as a posting in a newsfeed, on a profile webpage, or as a status update for one or more social network connection of the online shopper to see when the online shopper indicates a willingness to share in order to receive the incentive.

According to another embodiment provided is a method for encouraging an online shopper to share information about an online purchase transaction that includes offering an incentive to the online shopper and displaying a video featuring the product on a social network platform of the online shopper when the online shopper accepts the incentive. According to a preferred embodiment, the incentive is offered after an online product item has been added to an online shopping cart of the online shopper but prior to checkout.

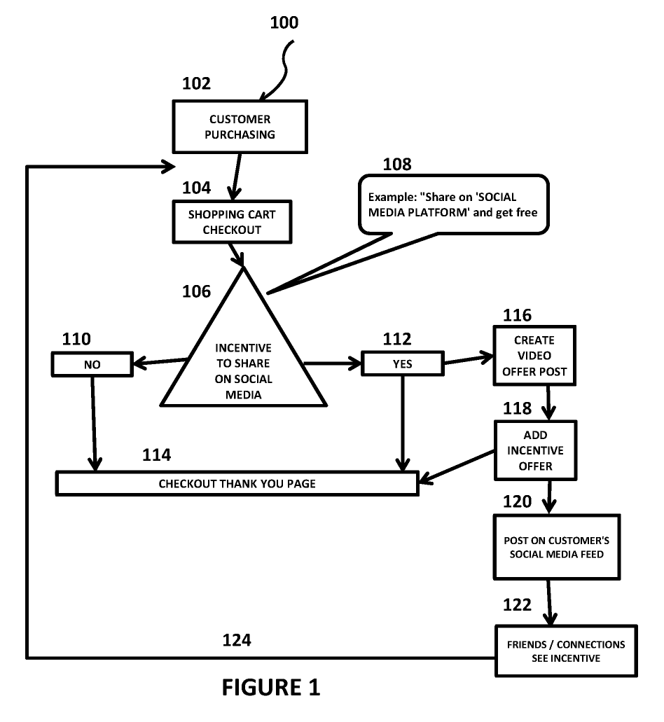

Referring now to the accompanying FIG. 1, a first embodiment 100 of the method is shown with the customer purchasing products 102 that end up in a virtual shopping cart 104 at the online checkout screen. At this point an incentive offer (e.g. discount, buy one get one free, etc.) appears 106 if the online shopper elects to redeem or take advantage of the incentive in exchange for sharing information about their purchase featuring the product with one or more social network connection on one or more social network platform. For example 108, the incentive could state something like “Share on SOCIAL MEDIA PLATFORM NAME and get free shipping!” If the online shopper is not interested in sharing 110, then he/she does not receive the incentive and progresses to the final checkout page 114.

However, if the online shopper is willing to share 112, then he/she is prompted to either choose one of several pre-made videos about the product to share on one or more of his/her social networks, or has the option to create their own video featuring the product or a statement/opinion about 116. The incentive offer is added 118 to the checkout total and next posted 120 on the online shopper's social network newsfeed, profile page, etc. along with the video. Social network connections or friends of the online shopper will then see 122 the video or a link thereto along with the incentive offer. Many will then be motivated to become purchasers themselves and the purchasing and sharing escalates to become viral.

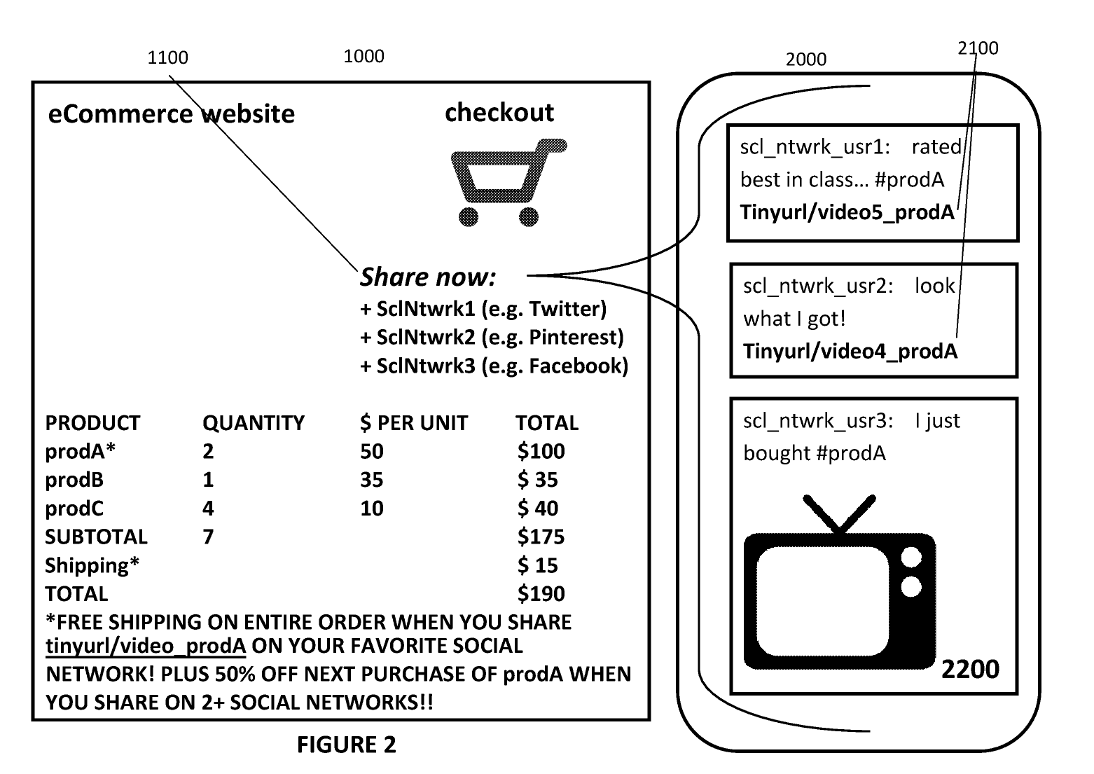

With reference to FIG. 2, a system according to an embodiment of the invention is shown to include an incentive offer or advertisement 1100 at the checkout screen 1000 of a website. When a shopper elects to redeem the incentive by sharing, a video 2200 featuring or promoting the product or a link 2100 thereto is posted on the shopper's newsfeed, profile webpage, etc. on a social networking website to which the online shopper belongs and where the online shopper has connections/contacts/friends/followers/etc. who will then see the news and be able to checkout the video of the product themselves. The incentive may be displayed again as well along with the video, in the video, or after clicking on the link to the video.

The video may also feature other additional products available for purchase with a few clicks and which may include further incentives for sharing or promoting across a purchaser's social network(s). As discussed above, the video may be selected according to the purchaser's taste and preference from one of several pre-made videos featuring the purchased product. Alternatively, the video may be created “on the fly” at the time of or after purchase by the purchaser, for example, featuring himself/herself as purchaser (“selfy”) with their smartphone camera. In other variations, static pictures may be selected or taken and shared to promote the product alternatively or additionally to dynamic videos.

FIG. 2a is a block diagram of components and steps of the invention. Online shopping cart 202 (or purchase enabled video player 204) may have therein a product 206.

In general, one unique aspect of the present invention is that it may be practiced inside of an embedded video player 204 which is purchase enabled. This software device is not similar to known video players such as Windows Media Player or VLC in that it is in fact able to function as a Point of Checkout module, as an alternative to an online shopping cart. Thus media player 204 (as discussed in greater detail in the related application for which priority and benefit is claimed above) is itself an entirely unique part of the ecosystem of this invention.

The online shopper, the “first” purchaser, initiates the actual purchase 208. In the present invention, essentially the entire operation, as seen by the consumer, will occur during the brief span of the purchase process (Point of Checkout, POC, checkout, etc).

The first in-purchase advertisement 210 may be inserted into the purchase automatically, at step 211. This occurs without any active pre-registration being required by the first purchaser, without the use of any special application, without setting up an MLM “shopping cart” beforehand, going to a store to scan QR codes or any other similar step. The offer explains to the purchaser that they might post to social media some sort of advertisement on behalf of the product they just purchased.

This advertisement might be anything more elaborate than a mere “like” or “thumbs up” indicia. But while the user might make their own advertisement, the preferred mode is to offer professionally created advertisements for their usage. Social advertisement choices 212 are thus presented to the first purchaser, who selects one of them for posting to social media platform 213.

The selected advertisement thus becomes the second social advertisement 214. Note that as used herein, the first advertisement is an in-purchase ad, while the second advertisement is a social media ad. Thus the platforms may be totally different and the form of the advertisements may be totally different. In addition, the content of the advertisements will be different as they are directed to different audiences: the first (in-purchase) ad is directed to someone who has already independently decided to buy the product 206, while the second (social media) ad is a social ad to let contacts of that buyer know about the product 206 and thus serves a different marketing purpose.

Insertion into social media 215 is important: this process needs to be so smooth that the first purchaser doesn't give up and end the transaction. Thus tools are provided to aid the insertion, the social media ad (advertisement two) is properly formatted for the social media platform and so on.

Purchase completion 216 may even be carried out after a brief interlude of advertisement, or it may be, as shown in FIG. 2A, after the purchase is completed and the purchase 208 is initiating shipping 220 of the actual product 222 and eventually (not shown) the second purchaser (or all targeted contacts of the first purchaser on the social media platform) receiving the second, very different advertisement.

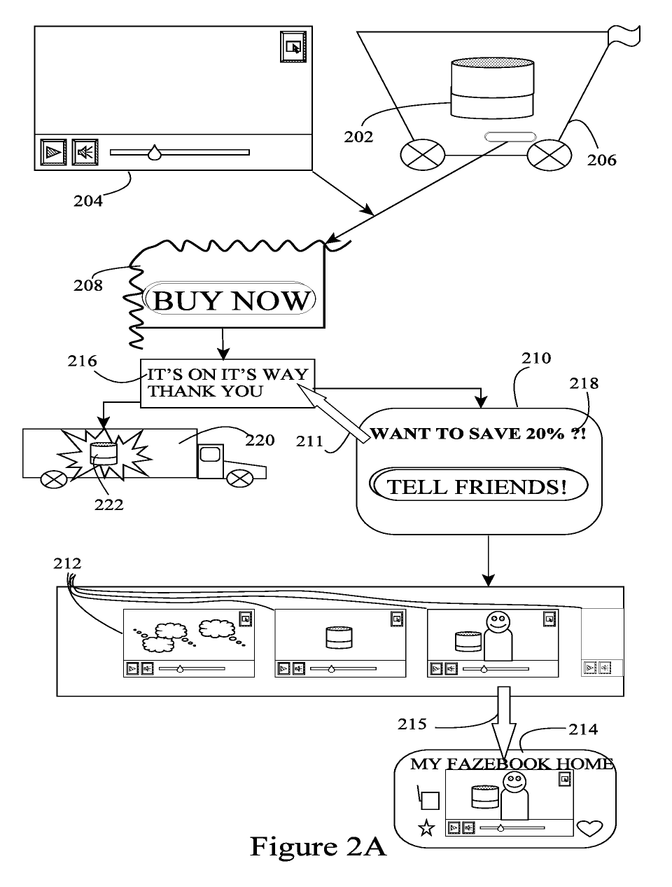

FIG. 3 is an exemplary chart of the spread of an advertisement according to the invention, through a partial social network, shown as a hierarchy for simplicity and clarity though social networks are in fact not usually hierarchical in organization. Also for simplicity, cross-discussions, replies, comments, off-line communication (DM) and other communications are not shown.

The particular diagram shown is for a hypothetical social network in which the rules are as follows: each user has an “area” or “bulletin board” or “wall” on which postings are placed: various example postings are shown along with the advertisement of the invention. However, postings are not placed by a first user themselves but rather by other users who the first user “follows” or “reposts” or “publishes”, that is, each user is encouraged under the rules of the social network to contribute to the areas of other users rather than their own. In turn, the areas on which such postings appear are seen by those (a third group) of users who “follow” the second user.

Thus, an example of the use of the invention shows first user/initial purchaser 302 posting on the area/wall of second user 304 both a companion advertisement 306 and a video component 308. This is in turn seen by third user 310. Note that in this example, third user 310 will actually get the same advertisement from two different sources, as he “follows” two different users who both follow first user 302.

Perhaps a more typical set of rules for a social network would be a rule in which each user posts to their own wall or area, however, the variation and use of the websites are extreme so all variations and embodiments are covered herein. If one imagines a situation in which the user 304 posts to his own wall, then the system can still be seen simply by ignoring 302 and other users below 302: instead, user 304 may post the comment, by means of the invention, to their own wall, where once again user 310 sees it. This simpler set of rules is one preferred embodiment and best mode now contemplated for carrying out the invention.

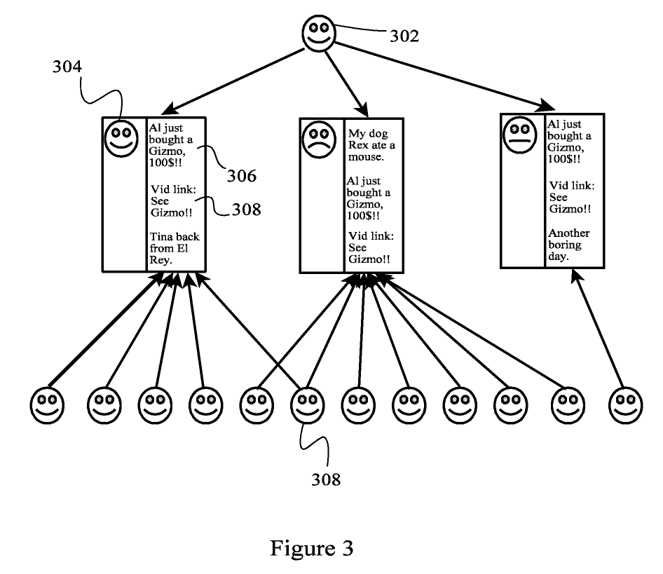

FIG. 4 is an exemplary block diagram of a partial social network in which users receive a score based upon their number of communication links with other users of the network. Since this is a partial view of a network, some connections are not shown, crossing connections are omitted and so on.

First user having 4 links 402 is represented by a small four pointed star. This individual might represent a fairly low use social networker, who is “followed” or “found” by only a handful of others. Second user having 0 links 404 may not be found at all.

However, third user having 8 links 406 is possibly about average for the social network, and has a score or rating assigned to them. Third user rating: “8” (408) may be seen to connect to a fourth user 410, who has a much larger number of contacts/followers/etc.

Fourth user rating: “32” (412) is the highest shown on this extremely simplified partial diagram, however, in real world social networks it is quite common to have hundreds of contacts/followers/friends/etc etc., and famous individuals or causes might have many millions. Obviously the present invention taps into the enormous potential of such power socializers: a single sale to such an individual might result in millions of views by other users.

It is thus very easy to see how an advertiser might make use of this information, which is often publically available. A simple method of scoring users might be to count their connections in the social network. Then the score might in turn be used to generate the level of incentive. For example, users 404 and 402 might not find any incentives when they go to purchase the first product (or designate it, for example by placing it in an electronic shopping cart), while user 406 might receive a nominal incentive (5% price discount, a small item, some small public recognition, membership, coupon, etc) while user 410 might receive a larger incentive: 10% off the price, a bonus item of more value, etc.

In addition, the number of contacts may be supplemented or supplanted by other methods of scoring users within the scope of the invention. For example, a greater incentive might be offered to those who post to more than a single social network. Similarly, other factors which might be used could include, but are not limited to, the number of social network connections of such first user, the number of social network connections of such second user to whom the first user is linked, a number of social networks to which such first user posts, a demographic indicia of such first user, a demographic indicia of such second user, and combinations thereof. Thus, user 406 might receive a large bonus due to being linked to user 410, who has larger score. Or, user 402 might represent an extremely desirable demographic, such as teens living in a particular zip code and thus receive a larger incentive offer.

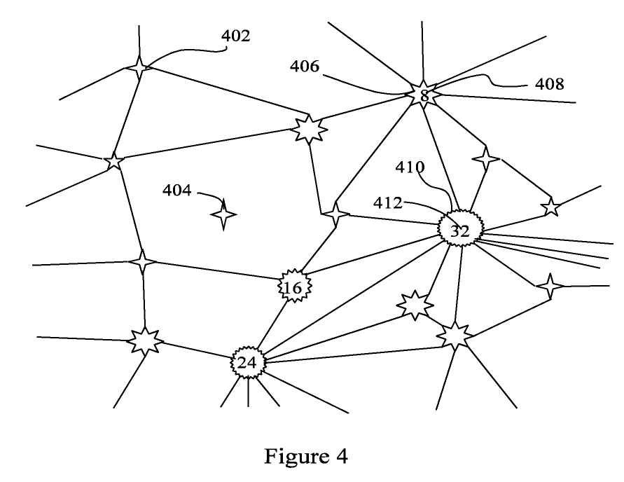

FIG. 5 is a block diagram showing physical components of a social network: though the physical components are the least important part of such a network they are shown for reference purposes. Social network/Internet 502 is not to be taken to indicate that social networks are confined to the Internet. Increasingly, “closed garden” communication protocols and product lineups are creating social networks which are not publically accessible. By volume of data transmitted as measured in gigabytes, it would seem that the private systems (such as those linked to the Apple corporation or the like) already are larger than the publically available Internet.

Merchant computer 504 may be used by a merchant to create pre-made videos of their own and otherwise manage the service, or a service provider of the social network advertising method of the invention might be creating the advertisements and managing the campaign from server computer having non-volatile memory 506, on which are programmed the components of the invention.

Consumer access device 508 is not shown as a traditional computer, although in fact it may be, simply because so many present day social network interactions and communications occur by means of portable devices such as phones, tablets, phablets, pads, pods and so on. Product (computer for sale) 510 may be seen to be displayed upon the social network in one advertisement form or another.

Video component 512 is one example format of advertisement, and the preferred embodiment and best mode now contemplated for carrying out the invention. Such a video may be arranged so that clicking on it takes a second user interested in the product to the point-of-checkout (POC) process, for example, by placing the advertised product into the second user's shopping cart. It may even, in conjunction with co-pending applications to the same inventors, provide the actual purchase of the product.

Video selection module 514 allows a user to select between different potential advertisements to display, as discussed previously in reference to FIG. 2, and further in reference to later figures. In FIG. 2, the topmost of advertisements 2100 might be considered suitable for a more business related social network such as Linkdln, while the second ad might be more appropriate for a more personal social network, or one with image display, such as Instagram.

Shipping module 516 performs the physical activity of shipping the product 510 to the user 302 after purchase.

User database 518 is another necessary component of the invention, allowing the advertising service provider or the merchant to keep track of what consumers they are dealing with, the social network commitment level of those users (a term embracing a user's interest level, online capability, willingness to share, the usability of their preferred social tools and so on), demographic and financial information and much more.

Finally other modules and components are simplified for clarity as block 520, however, all other functions and components discussed herein may also be programmed into the non-volatile memory of the central processor unit (computer) of server 506.

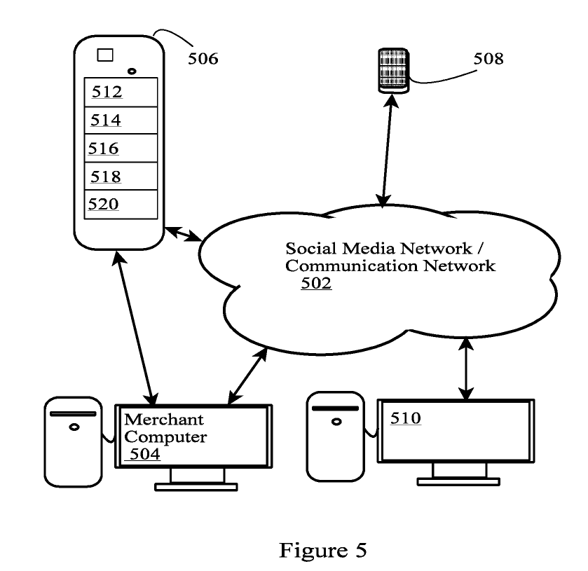

FIG. 6 is an exemplary tabular data structure showing potential video advertisements which a user might select from based upon various important dimensions of suitability. Thus, a user might decide that they want a business-like tone for their business oriented social network #3, and thus for that network choose to publish video vid022.mpg. Another network however, network #2, is seen by the same user's friends and an exited tone is appropriate for the purchase, so the user selects vid035.mpg for that particular advertisement. Not all cells of the array are necessarily present: there may be no useful video for the intersection of the business network #3 and a technical discussion.

In addition, the data structure shown is a two dimensional array but the invention is not in any way so limited. The actual dimensions on which the user might be offered choice would naturally include not just social network and tone but might also include product related choices, network topics of discussion, demographics of the friends on the network, and much more.

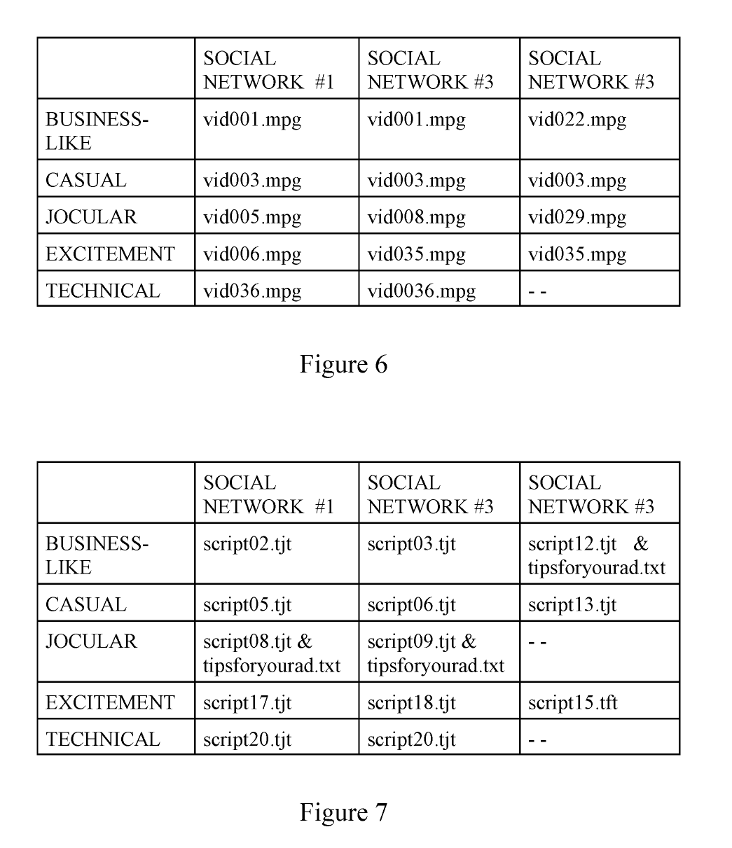

FIG. 7 is an exemplary tabular data structure showing potential non-video advertisements, or self-made advertisements or selfies, which a user might select from based upon various important dimensions of suitability. Thus, a user might want to put a script advertisement on social network #3, but would not desire to do so without the help of a pre-written script (script12.tjt) and a file of tips on how to make a video or post an appropriate ad: “tipsforyourad.txt”.

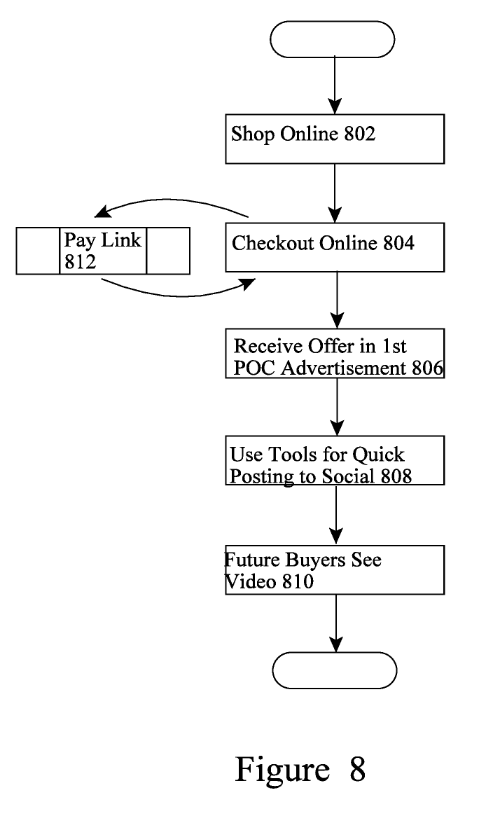

FIG. 8 is a flow chart of the steps of the invention for the provision of a service, and payment, by a provider to a customer. As may be seen this process is quite straightforward. Shopping online 802 may be accomplished normally, followed by checkout online at step 804 of the service desired.

The first user then receives the first in-purchase ad 806 which offers them an opportunity for a bit of quick and easy social media promotion. Using tools for a quick post, 808, the user then gets to finish the checkout immediately as they go to a payment link 812, which may be a simple payment system such as MOJOPAY®, a purchase enabled video player, a social link which provides payment, a combination thereof, or other more traditional options. Future buyers then see the video in step 810.

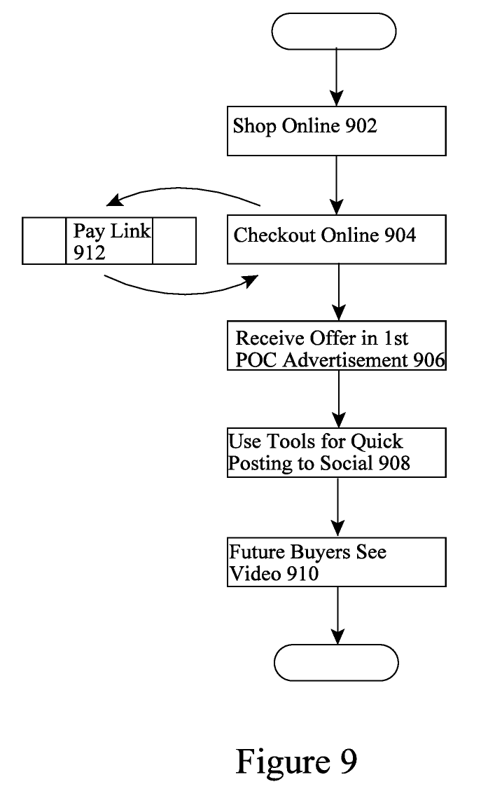

FIG. 9 is an almost identical flow chart of the same steps of the invention for the provision of a service, and payment, by a provider to a customer. As may be seen this process is still extremely straightforward. There is no need to download a special app and use it to scan QR codes, nor any need to register and bid as an MLM shopping cart operator or anything else. Shopping online 902 may be accomplished normally, followed by checkout online at step 904 of the service desired.

The first user then receives the first in-purchase/post-purchase ad 906, in this case for a product, which asks them for some social media promotion. Using tools for a convenient post of pre-made adverts, 908, the user then gets to finish the checkout immediately as they go to a payment link 912, which as previously stated may be a payment system such as MOJOPAY® for an online shopping cart, or instead might be a purchase enabled video player, or a social link which provides payment, or other more traditional options. Future purchasers, their associates on the social media platform, then see the video at step 910.

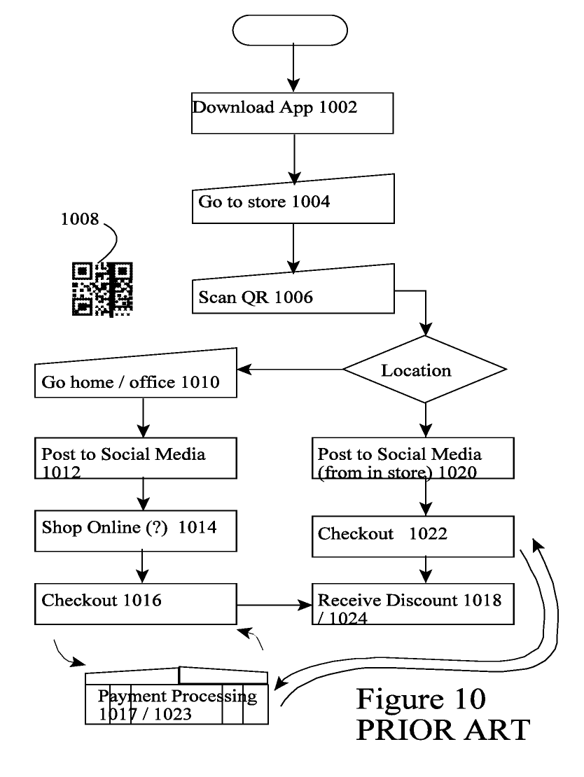

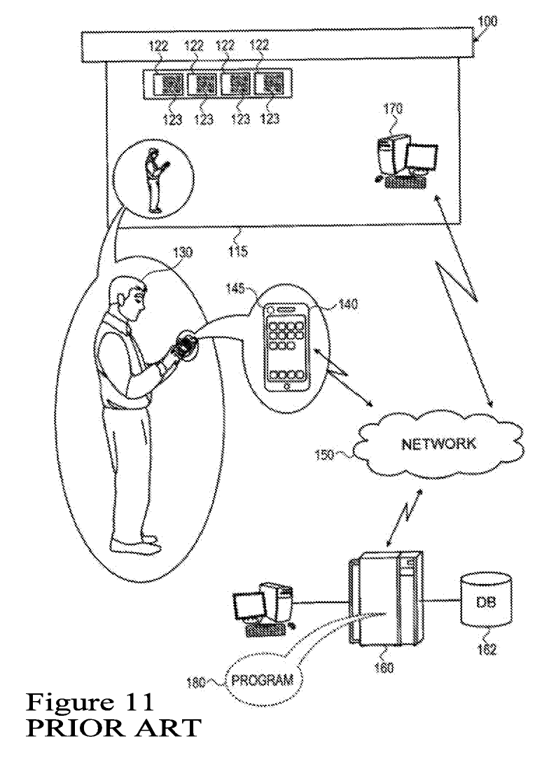

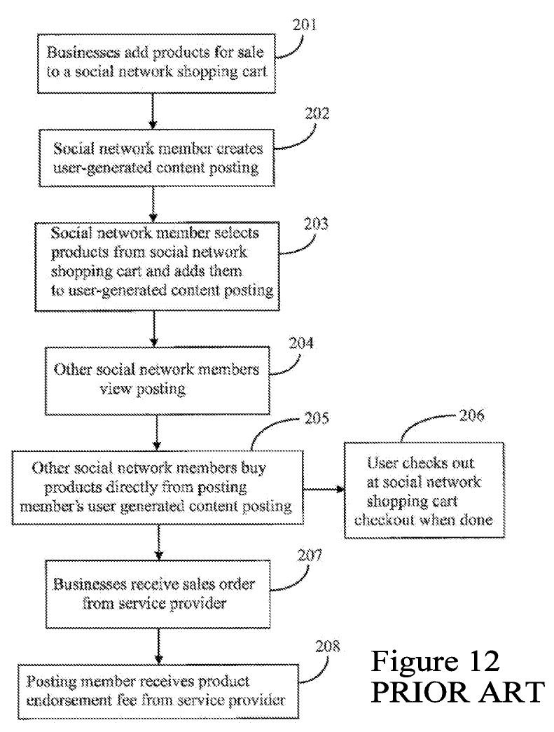

FIG. 10 is a PRIOR ART flowchart of steps of a user downloading and going to a store to scan QR codes. This is provided as contrast. The user must first download app at step 1002, then go shopping in a physical store at step 1004, where they scan QR codes 1006 (a QR code 1008 is shown). They then have a choice.

The user may go home 1010 or to another normal place to access the internet and social media and there, post 1012, and finally, and only after their trip to the store they may then shop online 1014, checkout 1016 and being the payment process 1017 during which hopefully they receive their discount (1018).

On the other hand, this option seems to be an afterthought in the Polak reference, found at paragraph 0081 only. More usually, the Polak reference anticipates the entire transaction occurring in-store. Post 1020 is done in-store, then the user may checkout 1022, use their payment process 1023 and finally receive discount 1024.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. An online purchase system in which a first purchaser may, in during an online purchase of a product from a first seller, the online purchase being made on a purchase enabled device which is a software device, push a message onto a social media platform where it may be viewed by a second purchaser, the online purchase system comprising:
a first in-purchase advertisement from such first seller, the first in-purchase advertisement including an offer to such first purchaser to make a push transmission to such second purchaser via such social media platform;
a first in-purchase advertisement insertion module operative to insert the first in-purchase advertisement into such purchase automatically;
the first in-purchase advertisement insertion module operating automatically and without prior preparation on the part of such first purchaser;
a social advertisement selection module operative to offer to such first purchaser a plurality of social advertisements of such product from amongst which such first purchaser may select a second social advertisement;
the second social advertisement having a format suitable for posting onto such social media platform;
a second social advertisement insertion module operative to insert the second social advertisement onto such social media platform, whereby such second purchaser may receive it;
the first in-purchase advertisement insertion module and the second social advertisement insertion module entirely operative during and after such purchase;
such purchase enabled device operative to complete such transaction, including accepting payment.

2. The online purchase system of claim 1, wherein such purchase enabled device further comprises:
an online shopping cart.

3. The online purchase system of claim 1, wherein the insertion of the second social advertisement onto such social media platform further comprises one member selected from the group consisting of: posting the second social advertisement in a newsfeed, posting the second social advertisement in a profile webpage, posting the second social advertisement as a status update, and other forms of social network posting now known or later devised, and combinations thereof, but excluding from this group posting an indicia of liking such product.

4. The online purchase system of claim 3, wherein the first in-purchase advertisement, second social advertisement, first in-purchase advertisement insertion module, second social advertisement insertion module, and such purchase enabled device are stored as programming in a non-volatile memory of a central processing unit.

5. The online purchasing system of claim 4, wherein such purchase enabled device is further operative to activate a shipping module, the shipping module operative to initiate a shipping process of such product to such first purchaser.

6. The online purchasing system of claim 5, wherein such purchase enabled device further comprises:
a purchase enabled video player operative to carry out such purchase, including at least the steps of: receiving from such first purchaser a notification of intention to buy such product, a step of automatically and without prior preparation on the part of such first purchaser inserting the first in-purchase advertisement into such purchase automatically, inserting the second social advertisement onto such social media platform.

7. The online purchasing system of claim 6, wherein the first in-purchase advertisement further comprises:
a first video, formatted to be played by the purchase enabled video player.

8. The online purchasing system of claim 7, wherein the second social advertisement further comprises:
a second video, formatted to be played after posting onto such social media platform.

9. The online purchasing system of claim 8, wherein the incentive to the second purchaser is a function of a number of social platform connections of such first purchaser.

10. The online purchasing system of claim 8, wherein the incentive to the second purchaser is a function of a number of social platforms to which such first purchaser posts the second social advertisement.

11. The online purchasing system of claim 10, wherein the plurality of social advertisements of such product from amongst which such first purchaser may select a second social advertisement are pre-recorded and formatted for immediate posting to such social platform by such first purchaser.

12. The online purchasing system of claim 10, wherein the second social advertisement is created by such first purchaser.

13. The online purchasing system of claim 12, wherein the second social advertisement further comprises: an embedded link operative to register a click from such second purchaser and in response activate such purchase enabled device, whereby such second user is enabled to purchase such product without activation of any software device other than such purchase enabled device.

14. An online purchase method in which a first purchaser may, in during an online purchase from a seller, the purchase made on a purchase enabled device, push a message onto a social media platform where it may be viewed by a second purchaser, the online purchase method comprising the steps of:
1) allowing such first purchaser to initiate such online purchase within such purchase enabled device;
2) during such online purchase, automatically display to such user a first in-purchase advertisement having an opportunity for making a second social advertisement to such second purchaser, the second social advertisement to be made via such social media platform, the first in-purchase advertisement inserted automatically into such online purchase without prior preparation by such first purchaser;
3) offering to such first purchaser a plurality of social advertisements of such product, from amongst which such first purchaser may select the second social advertisement; the second social advertisement having a format suitable for posting onto such social media platform;
4) posting the second social advertisement to such social media platform.

15. The online purchase method of claim 14, wherein such purchase enabled device further comprises:
a purchase enabled video player.

16. The online purchase method of claim 15, wherein the step 4) posting the second social advertisement to such social media platform further comprises one member selected from the group consisting of: posting the second social advertisement in a newsfeed, posting the second social advertisement in a profile webpage, posting the second social advertisement as a status update, and other forms of social network posting now known or later devised, and combinations thereof, but excluding from this group posting an indicia of liking such product.

17. The online purchase method of claim 16, wherein the first in-purchase advertisement, second social advertisement, and such purchase enabled device are stored as programming in a non-volatile memory of a central processing unit.

18. The online purchasing method of claim 17, wherein such purchase enabled device is further operative to activate a shipping module, the shipping module operative to initiate a shipping process of such product to such first purchaser.
